(19) United States
(12) Patent Application Publication
(10) Pub. No.: US 2014/0262853 A1
(43) Pub. Date: Sep. 18, 2014

(54) ADD-ON WALLETS AND CASES FOR HAND-HELD ELECTRONICS

(71) Applicant: Daniel A. DeChant, Madison, WI (US)

(72) Inventor: Daniel A. DeChant, Madison, WI (US)

(21) Appl. No.: 13/833,164

(22) Filed: Mar. 15, 2013

(51) Int. Cl. G06F 1/16; A45C 1/06

(52) U.S. Cl. CPC G06F 1/1628; A45C 1/06
USPC 206/45.2; 150/132

(57) ABSTRACT

The present invention provides add-on wallets and cases for attachment to hand-held electronic devices. The wallet comprises a central panel having a front and a back, and a device connecting element positioned on the back of the central panel, where the wallet is attached by the device connecting element to the hand-held electronic device. The wallet further includes wallet panels attached to the edges of the central panel. Various connection elements can be used to close the panels of the wallet, or allow the panels of the wallet to be configured in a stand position, to act as a stand for the hand-held electronic device. The wallets and cases also provide connection mechanisms to attach the wallets or cases to other external structures such as a portfolio folder, or a car dash board.

### BACKGROUND

The present invention relates to add-on wallets and cases for hand-held electronic devices, such as wireless phones and tablet style computers.

### SUMMARY

The present invention provides a number of different embodiments for wallets and cases for attachment to hand-held electronic devices.

In one embodiment, the invention provides a wallet coupled to a hand-held electronic device. The wallet comprises a central panel having a front and a back, a central pocket on the front of the central panel is configured to accommodate paper money, coins, cards, keys or other materials, and a device connecting element is positioned on the back of the central panel. The wallet is coupled to the hand-held device by a device connecting element. The central pocket on the front of the wallet can be a solid color, opaque, or made of a transparent material where one can see what is contained in the pocket. The pocket can also be of a framed design, with a transparent material “window” positioned in the frame section. The front of the central panel may also have a plurality of pockets. The pockets may also have a cut out tab section to allow any stored cards to be accessed by a finger. In another embodiment a pocket can be located on the back of the central panel, with the device connecting element attached to the outside of the pocket on the back of the central panel.

In another embodiment of the wallet, a wallet is provided as described above further including at least one wallet panel foldably coupled to the central panel. In some embodiments, multiple wallet panels may be included which can be foldably connected to the central panel, or to each other. Wallet panels have a front and back, and optionally a pocket, or pockets, which can be located on either the front or back of the wallet panel. In embodiments where the wallet panel has a pocket, the central panel may optionally not contain a pocket. The wallet panel, and any of the optional pockets on the wallet panels can be a solid color, opaque, or made of a transparent material. Any of the wallet pockets can also be of a framed design, with a transparent material “window” positioned in the frame section. The pockets on the wallet panel may also have a cut out tab section to allow any stored cards to be accessed by a finger. Multiple wallet panels can be coupled to the central panel, and to each other, to provide a bi-fold, tri-fold, and other multiple fold arrangements to the wallet. The wallet panels can be coupled to, or extend from, the edges of the central panel (top, bottom or sides) or any of the edges of any other wallet panel, thus providing a wallet that can open a top and bottomward fashion from the central panel, or a sideward fashion from the central panel, or have certain panels that open in a horizontal fashion, and others in a vertical fashion in the same wallet or case.

Any of the pockets of the wallet of the present invention can designed to secure any money, cards, coins, keys, or other items placed in the pocket by a snug friction fit. This can be done by designing an appropriate size of a pocket, or elastic or other stretch fabric can be used in the pocket design. In other embodiments the pockets can have a pocket closure element that can be used to close and secure the opening of the pocket.

The central panel, or any of the wallet panels, may also contain a wallet closure element to allow the wallet panels or central panels to be secured to each other allowing the wallet to be secured in a closed position. In one of these embodiments, the wallet comprises a central panel having a front and a back, and a device connecting element positioned on the back of the central panel, where the wallet is attached by the device connecting element to the hand-held electronic device. The wallet further includes a first and second wallet panel. The first wallet panel is foldably coupled to the central panel at a first edge and the second wallet panel is foldably coupled to the central panel at a second edge opposite the first edge. The first wallet panel includes a first wallet closure element on an inner surface the second wallet panel includes a second wallet closure element on an outer surface, wherein the first wallet closure element on the first wallet panel corresponds to the second wallet closure element on the second wallet panel in the closed position.

In other embodiments, the wallet panels may be arranged to be selectively coupled to each other by a stand coupling element such that they provide a stand position. The wallet panels are coupled together by way of stand coupling elements to provide the stand position. In one of these embodiments, the wallet comprises a central panel having a front and a back, and a device connecting element is positioned on the back of the central panel, where the wallet is attached by the device connecting element to the hand-held electronic device. The wallet further includes a first and second wallet panel. The first wallet panel is foldably coupled to the central panel at a first edge and the second wallet panel is foldably coupled to the central panel at a second edge opposite the first edge. The first wallet panel is selectively coupled to the second wallet panel to place the wallet in a stand position, by way of a stand coupling element.

In other embodiments of the wallet, the wallet is provided in a kit with additional components, such as a second device connection element. In this embodiment of the invention, a second device connection element is provided such that the hand-held device can be detached from the wallet and attached to another external structure (for instance a car dashboard) which has been fitted with the second device connection element. In this fashion, the hand-held device can be attached to both the wallet and the second device connection element in a removable fashion, such that the phone can be moved off the wallet and to the external structure, or vice versa.

In another embodiment, the invention provides a hand-held electronic case that can be attached to either a portfolio folder or anther external structure. In one embodiment the case comprises a central panel having a front and a back. The front of the central panel has a device connecting element. The case further includes first and second case panels, each case panel having inner and outer sides. The first case panel is foldably coupled to the central panel at a first edge and the second case panel is foldably coupled to the central panel at a second edge opposite the first edge. The first case panel can be selectively coupled to the second case panel to place the case in a stand position, by way of stand coupling elements positioned on the first and second case panels. The outer side of the first case panel has a first stand coupling element and the outer side of the second case panel has a second stand coupling element, such that when the first and second case panels are suitably folded to a stand position, the first and second stand coupling elements are engaged to each other securing the case in the stand position. The case further comprises a case coupling element that allows the case to be removably coupled to a portfolio folder or other external structure. The inner side of the second case panel has a case coupling element used to couple the case to an external structure.

The disclosure provides for other aspects and embodiments that will be apparent in light of the following detailed description and accompanying Figures.

### BRIEF DESCRIPTION OF THE DRAWINGS

FIG. 1 is a front perspective view of a single panel wallet according to one embodiment of the invention.

FIG. 2 is a front perspective view of a single panel wallet according to another embodiment of the invention.

FIG. 3 is a front perspective view of a horizontal bi-fold wallet in a closed position according to another embodiment of the invention.

FIG. 4 is a front perspective view of the horizontal bi-fold wallet in an open position.

FIG. 5 is a back view of the horizontal bi-fold wallet in an open position with the hand-held electronic device redacted to show the back side of the central panel.

FIG. 6 is a front perspective view of a horizontal bi-fold wallet in an open position with framed pockets according to another embodiment of the invention.

FIG. 7 is a front perspective view of a vertical bi-fold wallet in a closed position according to another embodiment of the invention.

FIG. 8 is a front perspective view of a vertical bi-fold wallet in an open position.

FIG. 9 is a front perspective view of a horizontal tri-fold wallet in a closed position according to another embodiment of the invention.

FIG. 10 is a front perspective view of the horizontal tri-fold wallet in an open position.

FIG. 11a and 11b are side views of a horizontal tri-fold wallet in a stand position.

FIG. 12 is a back perspective view of a horizontal tri-fold wallet in a stand position.

FIG. 13 is a front perspective view of a vertical tri-fold wallet in a closed position according to another embodiment of the invention.

FIG. 14 is a front perspective view of the vertical tri-fold wallet in an open position.

FIGS. 15a and 15b are side views of a vertical tri-fold wallet in a stand position.

FIG. 16 is a rear perspective view of a vertical tri-fold wallet in a stand position.

FIG. 17 is a front view of a vertical tri-fold case in a folded position according to another embodiment of the invention.

FIG. 18 is a back perspective view of a vertical tri-fold case in a closed position.

FIG. 19 is a front view of a vertical tri-fold case in an open position.

FIG. 20 is a back view of a vertical tri-fold case in an open position.

FIG. 21 is a side view of a vertical tri-fold case in a stand position.

FIG. 22 is a back perspective view of a vertical tri-fold case in a stand position.

FIG. 23 is a side view of a vertical tri-fold case mounted to a panel of a portfolio folder.

FIG. 24 is a side view of a vertical tri-fold case in a folded position.

FIG. 25 is a front open view of the vertical tri-fold case attached to a portfolio folder.

### DETAILED DESCRIPTION

Before any embodiments of the invention are explained in detail, it is to be understood that the invention is not limited in its application to the details of construction and the arrangement of components set forth in the following description or illustrated in the drawings. The invention is capable of other embodiments and of being practiced or of being carried out in various ways.

As used herein the term “hand-held electronic device” shall mean any portable or mobile electronic device, including any existing cases (i.e. not including the wallet or cases of this invention) that may be on the device, including aftermarket cases. Such devices include cell phones and tablet style computers.

As used herein the term “device connecting element” shall mean any permanent, semi-permanent (i.e. intended to be permanent by user, but can be removed unintentionally), and removable connecting element that couples a hand-held electronic device to the wallet or to an external structure. A removable device connecting element, allows the wallet, case or external structure to be removably attached and detached from the hand-held electronic device at the convenience of the user. Suitable removable device connecting elements include, but are not limited to: a hook and loop (i.e. Velcro) attachment (with either the hook or loop component being attached to the device, and the opposite hook or loop component being attached to the wallet, case or external structure); an elastic band or stretch fabric bands such as lycra, spandex or other similar material; a pocket that receives the hand-held electronic device and secures it to the wallet or case by partially enclosing the hand-held electronic device; a magnetic attachment (the magnetic attachment having two parts, wherein one part of the magnetic attachment is attached to the device, and the other part of magnetic attachment is attached to the wallet, case or external structure); or a removable adhesive that allows the hand-held electronic device to be attached to the wallet, case or external structure, but can be removed from such structures when sufficient force is provided, Command™ adhesive products from 3M Corporation of Minnesota, USA is an example of such an adhesive, though any suitable adhesive can be used. In other embodiments a permanent or semi-permanent device connecting element can be used such as a strong adhesive.

As used herein, the term “pocket closure element” means any suitable element that can close a pocket. Such suitable elements include a hook and loop enclosure, a toothed zipper, a channel zipper (i.e. a Ziplock mechanism), magnetic attachments, snaps, elastic band(s), stretch fabric bands such as lycra, spandex or other similar materials, or any other suitable closure elements.

As used herein the term “wallet closure element” or “case closure element” means any suitable element that allows the central or wallet panels to be removably secured to each other allowing the wallet to be secured in a closed position, but can be released to provide an open position. Suitable wallet closure elements may include a hook and loop enclosure, a toothed zipper, a channel zipper, magnetic attachments, snaps, a snapped loop tab, elastic band(s), stretch fabric bands such as lycra, spandex or other similar materials, or any other suitable closure elements.

As used herein the term “stand coupling element” means any suitable coupling element that can be used to removably couple any of the central, case or wallet panels to each other, such that the configuration of the case or wallet is secured in a stand position. The stand coupling element can be any suitable element that connects any of the central, wallet or case panels together securely to provide a suitable stand for the hand-held electronic device. Such elements can include a hook and loop attachment, magnetic attachments, snaps, an elastic band, stretch fabric bands such as lycra, spandex or other similar materials, a tab and tab receiving slot configuration, removable adhesive, or any other suitable coupling mechanism.

As used herein the term “stand position” shall mean wherein the central, wallet or case panels are positioned such that the hand-held device attached to the case or wallet is held in a propped up vertical position by the central, wallet or case panels.

As used herein a “case closure element” shall mean any suitable element that allows the central or case panels to be removably secured to each other allowing the case to be secured in a closed position, but can be released to provide an open position. Suitable case closure elements may include a hook and loop enclosure, a toothed zipper, a channel zipper, magnetic attachments, snaps, a snapped loop tab, elastic band(s), stretch fabric bands such as lycra, spandex or other similar materials, or any other suitable closure elements.

The materials of the various wallets and hand-held electronic cases below can be made of any suitable material. Suitable material includes, leather, fabric, cloth, plastic, vinyl, nylon, PVC, rubber, elastic, simulated leather, neoprene, tyvek, stretch fabrics such as lycra, spandex or other similar materials, or any other suitable material.

The pockets provided in the present invention can be optionally be present on any of the central, wallet or case panels. This would also include a plurality of pockets on any of these panels. The pockets can be of any suitably design. In one embodiment they are designed to hold cash money, credit cards, business cards, coins, keys or other objects. In other embodiments, larger pouched or gusseted pockets can be used to store coins or other bulkier objects. The pockets can be designed to provide a snug friction fit to keep objects in the pockets in place. This can be done by designing an appropriate size of a pocket, elastic or stretch fabrics can be used in the pocket design to aid in this friction fit, or to add expandability. In other embodiments the pockets can have a pocket closure element that can be used to close and secure the opening of the pocket. Any of the pockets can also optionally include a cut out tab section to allow any stored objects to be accessed by a finger, to aid in inserting and removing items from the pocket. The pockets can be a solid color, opaque, or made of a transparent material where one can see what is contained in the pocket. The pocket can also be of a framed design, wherein a border is provided on the outside of a pocket, the border providing a frame surrounding a transparent material “window” positioned in the frame section.

FIG. 1 illustrates a wallet configuration 100 featuring a single panel according to one embodiment of the invention. The wallet configuration 100 includes a single central panel 104 with a front side 108 and an opposite back side 110. The single panel 104 includes a device connecting element 112 placed on the back side 110 for connecting the hand-held wireless device 50. The single central panel 104 also includes a pocket 114 on the front side 108. The illustrated pocket 120 is a slotted pocket with a solid piece of material covering the majority of the front side 108. In another embodiment as shown in FIG. 2, the wallet 100 includes a framed pocket 116 positioned on the front side 108. The framed pocket 116 includes a clear window 118 (e.g., clear PVC) and a trim 120 surrounding the periphery of the clear window 118.

FIGS. 3-6 illustrates a horizontal bi-fold wallet configuration 200 according to another embodiment of the invention. The wallet configuration 200 includes a central panel 204 having a front side 208 and a back side 210, and a wallet panel 220 having an inner side 228 and an outer side 230. The central panel 204 and the wallet panel 220 are foldably coupled together along a side edge 240 of the central panel 204 providing a vertical fold 242, with vertical being defined as up and down in FIG. 4. The wallet panel 220 is foldable along the fold 242 to allow the wallet 200 to move between an open position (FIG. 4) to a closed position (FIG. 3). The back side 210 of the central panel 204 includes a device connecting element 250, in this specific example adhesive strips are used, to attach the wallet 200 to the hand-held electronic device 50. Wallet closure elements 290, in this embodiment hook and loop attachments, are positioned on the inner side 228 of the wallet panel 220 and the front side 208 of the central panel 204. Pockets 260 are positioned on the front side 208 of the central panel 204 and on the inner side 228 of the wallet panel 220. Alternatively, as shown in FIG. 6 the front side 208 and the inner side 228 include framed pockets 270.

FIGS. 7-8 illustrates another embodiment of a bi-fold wallet where the wallet opens a vertical direction, with vertical being defined as up and down in FIG. 8. In this embodiment the wallet panel 220 is foldably coupled to the central panel 204 along the top edge 280 of the central panel 204 providing a horizontal fold 282, with horizontal being defined as the right and left sides in FIG. 6.

FIGS. 9-12 illustrates a horizontal tri-fold wallet configuration 300 according to another embodiment of the invention. The wallet configuration 300 includes a central panel 304 having a front side 306 and a back side 308. A first wallet panel 310 is foldably coupled to the central panel 304 along a first side edge 312 of the central panel 304 providing a first vertical fold 314 with vertical being defined as up and down in FIG. 10. The first wallet panel 310 has an inner side 315 and an outer side 316. A second wallet panel 320 is foldably coupled to the central panel 304 along a second side edge 322 of the central panel 304 providing a second vertical fold 324 with vertical being defined as up and down in FIG. 8. The second wallet panel 320 has an inner side 325 and an outer side 326. The wallet panels 310 and 320 are foldable along the folds 314 and 324 to allow the wallet 300 to move between an open position (FIG. 10) to a closed position (FIG. 9). The back side 308 of the central panel 304 includes a device connecting element 350, in this specific example an adhesive, to attach the wallet 300 to the hand-held electronic device 50. Pockets 360 are positioned on the inner 315 side of the first wallet panel 301, and on the inner side 325 of the second wallet panel 320. The inner side 315 of the first wallet panel 310 has a first stand coupling element 317 (in this embodiment a hook portion), and the inner side 325 of the second wallet panel 320 has a second stand coupling element 327 (in this embodiment a loop portion) adjacent to a stand coupling fold 328. As shown in FIGS. 11-12, wherein the first 310 and second 320 wallet panels are folded in a stand position and first 317 and second 327 stand coupling elements are engaged to each other securing the wallet 300 in the stand position. Also, the outer side 326 of the second wallet panel 320 has a wallet closure element 329, in this embodiment a loop portion. When the wallet 300 is in a closed position, the hook portion of the first stand closure element 317 and the loop portion of the wallet closure element 329 meet and secure the wallet 300 in a closed position.

FIGS. 13-16 illustrates another embodiment of a tri-fold wallet where the wallet opens a vertical direction, with vertical being defined as up and down in FIG. 7. In this embodiment the first 310 and second 320 wallet panels are foldably coupled to the central panel 304 along the bottom edge 380 and top edge 382 respectively of the central panel 304 providing horizontal folds 384 and 385, with horizontal being defined as the right and left sides in FIG. 14.

FIGS. 17-25 illustrates a vertical tri-fold case configuration 400 according to another embodiment of the invention. The case configuration 400 includes a central panel 404 having a inner side 406 and an outer side 408. A first case panel 410 is foldably coupled to the central panel 404 along a first side edge 412 of the central panel 404 providing a first horizontal fold 414 with horizontal being side to side as shown in FIG. 19. The first case panel 410 has an inner side 415 and an outer side 416. A second case panel 420 is foldably coupled to the central panel 404 along a second side edge 422 of the central panel 404 providing a second horizontal fold 424 with horizontal being defined as side to side in FIG. 19. The second case panel 420 has an inner side 425 and an outer side 426. The case panels 410 and 420 are foldable along the folds 414 and 424 to allow the case 400 to move between an open position (FIG. 19) to a folded position (FIG. 17). The inner side 406 of the central panel 404 includes a device connecting element 450, in this specific example a pocket, to secure the case 400 to the hand-held electronic device 50. The outer side 416 of the first case panel 410 has a first stand coupling element 417 (in this embodiment a hook portion), adjacent to a stand coupling fold 428. The outer side 426 of the second case panel 420 has a second stand coupling element 427 (in this embodiment a loop portion). As shown in FIGS. 21-22, wherein the first 410 and second 420 case panels are folded in a stand position and first 417 and second 427 stand coupling elements are engaged to each other securing the wallet 400 in the stand position. The inner side 425 of the second case panel 420 has case coupling elements 490 at the top and bottom of the second case panel 420 (when viewed vertically). In this embodiment the case coupling elements 490 are hook portions. The hook portion of the case coupling elements 490 can be connecting to hoop portions secured on an external structure such as a portfolio folder 500 as shown in FIGS. 23 and 25. Also, the inner side 415 of the first case panel 410 has a case closure element 429, in this embodiment a hook portion. When the case 400 is in a folded position, the loop portion of the second stand coupling element 427 and the hook portion of the case closure element 429 meet and secure the case 400 in a folded position.

While the present invention has now been described and exemplified with some specificity, those skilled in the art will appreciate the various modifications, including variations, additions, and omissions that may be made in what has been described. Accordingly, it is intended that these modifications also be encompassed by the present invention and that the scope of the present invention be limited solely by the broadest interpretation that lawfully can be accorded the appended claims

1. A wallet for a hand-held electronic device, the wallet comprising:
a central panel having a front and a back;
a device connecting element on the back of the central panel,
wherein the wallet is attached to the hand-held electronic device.

2. The wallet of claim 1 wherein the wallet is removably attached to the hand-held electronic device.

3. The wallet of claim 1 wherein the wallet is permanently attached to the hand-held electronic device.

4. The wallet of claim 1 further comprising at least one pocket on the front of the central panel.

5. The wallet of claim 1 further comprising at least one pocket on the back of the central panel.

6. The wallet of claim 2, wherein the device connecting element is selected from a group consisting of a hook and loop attachment, an elastic band, a stretch fabric arrangement, a pocket, a magnetic attachment, or a removable adhesive.

7. The wallet of claim 3 wherein the device connecting element is an adhesive.

8. The wallet of claim 1, further comprising a wallet panel having an outside and an inside, the wallet panel foldably coupled to the central panel, and a pocket positioned on inside of the wallet panel.

9. The wallet of claim 8 wherein the wallet is removably attached to the hand-held electronic device.

10. The wallet of claim 9 wherein the device connecting element is selected from a group consisting of a hook and loop attachment, an elastic band, a stretch fabric arrangement, a pocket, a magnetic attachment, or a removable adhesive.

11. The wallet of claim 8 wherein the wallet is permanently attached to the hand-held electronic device.

12. The wallet of claim 11 wherein the device connecting element is an adhesive.

13. The wallet of claim 1 further comprising a first wallet panel having an inside and an outside, and a second wallet panel having an inside and an outside, the first wallet panel foldably coupled to the central panel at a first edge and the second wallet panel foldably coupled to the central panel at a second edge opposite the first edge.

14. The wallet of claim 13, wherein the first wallet panel is selectively coupled to the second wallet panel to place the wallet in a stand position, wherein:
the first wallet panel includes a first stand coupling element on its inner or outer surface
the second wallet panel includes a second stand coupling element on its inner or outer surface, wherein the first and second wallet panels are folded in a stand position and first and second stand coupling elements are engaged to each other securing the wallet in the stand position.

15. The wallet of claim 14 wherein the wallet is removably attached to the hand-held electronic device.

16. The wallet of claim 15 wherein the device connecting element is selected from a group consisting of a hook and loop attachment, an elastic band, a stretch fabric arrangement, a pocket, a magnetic attachment, or a removable adhesive.

17. The wallet of claim 14 wherein the wallet is permanently attached to the hand-held electronic device.

18. The wallet of claim 17 wherein the device connecting element is an adhesive.

19. The wallet of claim 14 wherein the first and second stand coupling elements are selected from a group consisting of a hook and loop attachment, magnetic attachments, snaps, an elastic band, a stretch fabric arrangement, removable adhesive, and a tab and tab receiving slot configuration.

20. A kit comprising the wallet of claim 2 and a second device connecting element which is designed to attach to an external structure.

21. A kit comprising the wallet of claim 9 and a second device connecting element which is designed to attach to an external structure.

22. A kit comprising the wallet of claim 13 and a second device connecting element which is designed to attach to an external structure.

23. A kit comprising the wallet of claim 15 and a second device connecting element which is designed to attach to an external structure.

24. A case for a hand-held electronic device, the wallet comprising:
a central panel having an inner side and an outer side, the inner side of the central panel having a device connecting element;
a first case panel having an inner side and an outer side, the first case panel foldably coupled to the central panel at a first edge, and the outer side of the first case panel having a first stand coupling element;
a second case panel having an inner side and an outer side, the second case panel foldably coupled to the central panel at a second edge opposite the first edge, and the outer side of the second case panel having a first stand coupling element, and the inner side of the second case panel having a case coupling element;
wherein the first and second case panels are folded in a stand position and the first and second stand coupling elements are engaged to each other securing the case in the stand position; and
wherein the case coupling element couples the case to an external structure.

25. The case of claim 24 wherein the external structure is a portfolio folder having an outside and an inside surface, wherein the case is coupled to the inside surface of the portfolio folder by the case coupling element.

26. The case of claim 24 wherein the case coupling element is selected from a group consisting of a hook and loop attachment, an elastic band, a stretch fabric arrangement, a pocket, a magnetic attachment, removable adhesive, or a snap.
